(19) United States
(12) Patent Application Publication
(10) Pub. No.: US 2013/0038670 A1
(43) Pub. Date: Feb. 14, 2013

(54) Printing Device with Marking Function

(71) Applicant: PRIMAX ELECTRONICS LTD., TAIPEI (TW)

(72) Inventor: Yi-Liang Chen, Taipei (TW)

(73) Assignee: PRIMAX ELECTRONICS LTD., TAIPEI (TW)

(21) Appl. No.: 13/663,136

(22) Filed: Oct. 29, 2012

Related U.S. Application Data
(63) Continuation-in-part of application No. 12/908,743, filed on Oct. 20, 2010.

(30) Foreign Application Priority Data
Aug. 13, 2010 (TW) 099215570

(51) Int. Cl. B41J 2/01

(52) U.S. Cl. 347/107

(57) ABSTRACT

A printing device with a marking function is provided. The printing device includes a printing module, an identification module and a marking member. The printing module is used for printing images on a transfer paper, thereby producing a barcode paper. The identification module is used for scanning the barcode paper, and judging the printing quality of the barcode paper. If the printing quality of the barcode paper is unqualified, the marking member produces a mark on the barcode paper. In addition, the barcode paper is successively transported through the printing module, the identification module and the marking member.

### CROSS-REFERENCE TO RELATED APPLICATION

This application is a continuation-in-part of U.S. Non-Provisional application Ser. No. 12/908,743, filed Oct. 20, 2010, whose disclosure is hereby incorporated by reference in its entirety into the present disclosure.

### FIELD OF THE INVENTION

The present invention relates to a printing device, and more particularly to a printing device with a marking function.

### BACKGROUND OF THE INVENTION

Printing devices are peripherals for printing characters and/or graphics on papers or other kinds of printing media. Generally, the printing devices are classified into two types: ordinary printing devices and thermal transfer printing devices.

The configurations of the thermal transfer printing devices are substantially identical to those of the ordinary printing devices except for the way of printing on the media. For example, the ordinary printing device supplies ink or toner onto a paper. Whereas, a thermal transfer printing device uses a thermal print head (TPH) to heat a ribbon to allow the coating of the ribbon to be adsorbed on a transfer paper. The common thermal transfer printing devices include for example faxing machines, the POS (Point of Sale) printers and barcode printers.

The conventional thermal transfer printing devices have been widely used. Among these conventional thermal transfer printing devices, since the barcode printers are usually used to print images on so many barcode papers, the long-term uses of the barcode printers may cause deteriorated printing quality. For checking the printing quality of the barcode paper, the printed barcode papers should be one by one examined with the naked eyes to find the barcode papers that have much inferior printing quality. Since some defective barcode papers fail to be directly examined with the naked eyes, an additional scanning device should be used to examine the barcode papers. In other words, the process of examining the barcode papers is very time-consuming and the process of operating the scanning device is labor-intensive. For solving these drawbacks, it is necessary to develop a thermal transfer printing device having the functions of examining the printing quality and marking the unqualified barcode papers.

Recently, a thermal transfer printing device with a marking function has been disclosed and commercially available. FIG. 1 is a schematic side view illustrating a thermal transfer printing device with a marking function according to the prior art. FIG. 2 is a schematic side view illustrating the thermal transfer printing device of FIG. 1 and taken along another viewpoint. Please refer to FIGS. 1 and 2. The thermal transfer printing device 1 comprises a casing 10, a thermal transfer printing module 11, a first power-providing device 12, a first gear set 13, a second power-providing device 14, a second gear set 15, a third power-providing device 16, a transmission mechanism 17, an external identification module 18 and a controlling unit 19. The thermal transfer printing module 11 comprises a ribbon transport module 111, a transfer paper transport module 112, a thermal print head 113 and a print roller 114. A ribbon R of the ribbon transport module 111 is transported through the region between the thermal print head 113 and the print roller 114. Similarly, a transfer paper M of the transfer paper transport module 112 is transported through the region between the thermal print head 113 and the print roller 114. The transfer paper M comprises a releasing paper part M1 and a medium part M2. The medium part M2 is disposed over the releasing paper part Ml. The thermal print head 113 is used for heating the ribbon R to allow the coating of the ribbon R to be adsorbed on the medium part M2 of the transfer paper M. In such way, a thermal transfer printing operation is performed to print the medium part M2 as a barcode paper M3. The print roller 114 is used for transporting the ribbon R and the transfer paper M and facilitating the thermal print head 113 to stably perform the thermal transfer printing operation.

As shown in FIG. 1, the ribbon transport module 111 comprises a ribbon supplying terminal 1111, a ribbon recovering terminal 1112, a first tension shaft 1113 and a second tension shaft 1114. The ribbon R is stored in the ribbon supplying terminal 1111. An end of the ribbon R is wound around and the fixed in the ribbon recovering terminal 1112. Due to the first tension shaft 1113 and the second tension shaft 1114, a tension force is exerted on the ribbon R. When the ribbon supplying terminal 1111 is driven to rotate, the ribbon R is transmitted from the ribbon supplying terminal 1111 to the ribbon recovering terminal 1112. The transfer paper transport module 112 comprises a transfer paper supplying terminal 1121, a transfer paper recovering terminal 1122, a third tension shaft 1123 and a fourth tension shaft 1124. The configurations and functions of the transfer paper transport module 112 are very similar to the ribbon transport module 111. The transfer paper M is stored in the transfer paper supplying terminal 1121. An end of the transfer paper M is wound around and the fixed in the transfer paper recovering terminal 1122. Due to the third tension shaft 1123 and the fourth tension shaft 1124, a tension force is exerted on the transfer paper M. When the transfer paper recovering terminal 1122 is driven to rotate, the transfer paper M is transmitted from the transfer paper supplying terminal 1121 to the transfer paper recovering terminal 1122.

As shown in FIG. 2, the external identification module 18 is disposed on the casing 10 and arranged outside the casing 10. The external identification module 18 is used for scanning the printed barcode paper M3. For example, the external identification module 18 is a scanning module. From the relative locations as shown in FIGS. 1 and 2, the first gear set 13 is connected with the ribbon recovering terminal 1112, the second gear set 15 is connected with the transfer paper recovering terminal 1122, and the transmission mechanism 17 is connected with the print roller 114. The first power-providing device 12 is connected with the first gear set 13 for providing motive power to the first gear set 13 to drive rotation of the ribbon recovering terminal 1112. The second power-providing device 14 is connected with the second gear set 15 for providing motive power to the second gear set 15 to drive rotation of the transfer paper recovering terminal 1122. In addition, the third power-providing device 16 is connected with the transmission mechanism 17 for providing motive power to the transmission mechanism 17 to drive rotation of the print roller 114. For example, the first power-providing device 12, the second power-providing device 14 and the third power-providing device 16 are motors. The controlling unit 19 is connected with the first power-providing device 12, the second power-providing device 14, the third power-providing device 16 and the external identification module 18 for enabling or disabling the first power-providing device 12, the second power-providing device 14 and the third power-providing device 16, and judging whether the printing quality of the barcode paper M3 is acceptable or unqualified.

During operations of the thermal transfer printing device 1, the first power-providing device 12, the second power-providing device 14 and the third power-providing device 16 are enabled. As such, the ribbon R is transmitted from the ribbon supplying terminal 1111 to the ribbon recovering terminal 1112, and the transfer paper M is transmitted from the transfer paper supplying terminal 1121 to the transfer paper recovering terminal 1122. At the same time, the print roller 114 is rotated. When the transfer paper M is transported through the region between the thermal print head 113 and the print roller 114, the thermal print head 113 performs a thermal transfer printing operation. In such way, the medium part M2 of the transfer paper M is printed as a barcode paper M3. As the print roller 114 and the transfer paper recovering terminal 1122 are continuously rotated, the releasing paper part M1 is detached from the barcode paper M3. The releasing paper part M1 is transmitted to the transfer paper recovering terminal 1122, but the barcode paper M3 is ejected out of the casing 10. When the barcode paper M3 is ejected out of the casing 10, a light beam B emitted from the external identification module 18 is projected on the barcode paper M3 to scan the barcode paper M3. According to the scanned image of the barcode paper M3, the controlling unit 19 will judge whether the scanning quality is acceptable. If the controlling unit 19 judges that the scanning quality is acceptable, the barcode paper M3 is continuously ejected out of the casing 10 and departed from the thermal transfer printing device 1. Whereas, if the controlling unit 19 judges that the scanning quality is not acceptable, the controlling unit 19 will control a reverse rotation of the print roller 114. Upon the reverse rotation of the print roller 114, the barcode paper M3 is transmitted to the region between the between the thermal print head 113 and the print roller 114, and the thermal print head 113 performs a thermal transfer printing operation on the barcode paper M3. In such way, an unqualified mark is printed on the barcode paper M3. The barcode paper M3 with the unqualified mark is then ejected to be identified by the user.

According to the above operating method of the conventional thermal transfer printing device, the user may identify the scanning quality of the barcode paper by judging whether the barcode paper has any unqualified mark. Although the conventional thermal transfer printing device has the functions of examining the printing quality and marking the unqualified barcode papers, there are still some drawbacks. For example, when the unqualified mark is printed on the unqualified barcode paper by the conventional thermal transfer printing device, the print roller should be controlled to be reversely rotated to have the unqualified barcode paper pass through the thermal print head again. In addition, after the unqualified mark is printed on the unqualified barcode paper, the print roller should be controlled to be normally rotated to eject the unqualified barcode paper. In other words, for printing the unqualified mark by the conventional thermal transfer printing device, the controlling unit should perform precise computation and accurately cooperate with the print roller. For avoiding erroneous operation, the reliability of the conventional thermal transfer printing device should be extremely high.

Moreover, since the transfer paper needs to be returned to the location of the thermal print head when the unqualified mark is printed by the conventional thermal transfer printing device, the unqualified mark by the conventional thermal transfer printing device should have plural power-providing device. For avoiding bending the ribbon and transfer paper and eliminating occurrence of the mutual interference between the ribbon and transfer paper, while the transfer paper is returned back to the print roller, the ribbon transfer module and the transfer paper transport module are not moved. However, during the transfer paper is returned back, the transfer paper between the thermal print head and the transfer paper supplying terminal is easily bent to lose the tension force. Under this circumstance, the transfer paper is possibly damage and thus the printing quality is impaired.

### SUMMARY OF THE INVENTION

It is an object of the present invention to design an improved printing device that is capable of determining the quality of the barcode papers without a complex control module and the conventional precise calculation for the barcode inspection.

It is another object of the present invention to provide an improved printing device without the needs of three power-providing devices to drive the ribbon transport module, the transfer paper transport module and the print roller.

It is another object of the present invention provides a preset barcode standard that comprises barcode standard parameters and conditions such as, modulation, contrast, non-uniformity and determination according to linear barcode requirements or 2D matrix symbol standards. The conditions and parameters of the preset barcode standard are adjustable to different barcode standards.

It is another object of the present invention to provide an improved printing device that the barcode paper does not transfer back to the thermal printing head and the print roller of the printing module once it is disqualified from the inspection. The present invention provides a printing device with a marking function, which the process of printing a mark is performed without complex control and computation process.

In according to one of preferred embodiments of the present invention, the printing device comprises a marking member that further consists of a marking head coupled with a solenoid valve, wherein the solenoid valve guides the marking head to move with respect to the barcode paper, either away or toward the barcode paper. The barcode paper is marked with an opening or a mark by the marking head of the printing device when it is disqualified from the inspection process. The marking head of the printing device further comprises an ink cartridge and a marking pad, in which it is functioned like a pen-ball ink cartridge that the ink in the ink cartridge is injected out once the marking pad is pressured.

In accordance with a preferred embodiment of the present invention, there is provided a printing device with a marking function. The printing device further comprises a printing module, an identification module, a power-providing device and the marking member. The printing module is used for performing a printing operation to produce a barcode paper, and transporting the barcode paper. The identification module is disposed beside the printing module, and has a preset barcode standard. According to the preset barcode standard, the identification module judges whether the barcode paper is identical to the preset barcode standard. The power-providing device is connected with the printing module and the identification module for providing motive power to the printing module and the identification module. The marking member is connected with the identification module. If the identification module judges that the barcode paper is different from the preset barcode standard, the marking member produces a mark on the barcode paper. The barcode paper is successively transported through the printing module, the identification module and the marking member.

In an embodiment, the printing module includes a ribbon transport module, a transfer paper transport module, a thermal print head and a print roller. The ribbon transport module is used for transmitting a ribbon from a ribbon supplying terminal to a ribbon recovering terminal. The transfer paper transport module is used for transmitting a transfer paper from a transfer paper supplying terminal to a transfer paper recovering terminal. The transfer paper includes a releasing paper part and a medium part disposed on the releasing paper part. The thermal print head is arranged between the ribbon transport module and the transfer paper transport module for performing the printing operation on the medium part of the transfer paper through the ribbon, thereby printing the medium part as the barcode paper. The print roller is arranged beside the thermal print head for transporting the transfer paper, so that the transfer paper is transmitted to the identification module.

In one of preferred embodiments, the ribbon transport module includes a first tension shaft and a second tension shaft. The first tension shaft is arranged between the ribbon supplying terminal and the thermal print head for applying a first tension force to the ribbon. The second tension shaft is arranged between the thermal print head and the ribbon recovering terminal for applying the first tension force to the ribbon.

In one of preferred embodiments, the transfer paper transport module includes a third tension shaft and a fourth tension shaft. The third tension shaft is arranged between the transfer paper supplying terminal and the thermal print head for applying a second tension force to the transfer paper. The fourth tension shaft is arranged between the thermal print head and the transfer paper recovering terminal for applying the second tension force to the transfer paper.

In one of preferred embodiments, the printing device further includes a sensor, which is connected with the printing module for detecting a thickness of the transfer paper. When the thickness of the transfer paper detected by the sensor is changed from a first thickness to a second thickness greater than the first thickness, the sensor issues a driving signal to the printing module to enable the printing module. The first thickness is equal to a thickness of the releasing paper part. The second thickness is equal to an overall thickness of the medium part and the releasing paper part.

In one of preferred embodiments, the identification module includes a scanning element, a controlling unit, a first transport roller assembly and a second transport roller assembly. The scanning element is used for scanning the barcode paper, thereby acquiring a scanned barcode image. The controlling unit is connected with the scanning element, and stores the preset barcode standard. By comparing the scanned barcode image with the preset barcode standard, the controlling unit judges whether the scanned barcode image is identical to the preset barcode standard. The first transport roller assembly is arranged at a first side of the scanning element for transporting the barcode paper through the scanning element. The second transport roller assembly is arranged at a second side of the scanning element for transporting the barcode paper to be departed from the scanning element without transferring back to the thermal printing head and the print roller of the printing module.

In one of preferred embodiments, the scanning element is a contact image sensor (CIS).

In one of preferred embodiments, the marking head is a seal, a punching head or a trimming knife, and the mark is an unqualified symbol, an opening or a notch.

In one of preferred embodiments, the printing device further includes a gear set. The gear set is connected with the power-providing device, the printing module and the identification module for receiving the motive power from the power-providing device, and transmitting the motive power to the printing module and the identification module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a thermal transfer printing device with a marking function according to the prior art;

FIG. 2 is a schematic side view illustrating the thermal transfer printing device of FIG. 1 and taken along another viewpoint;

FIG. 3 is a schematic side view illustrating the outward appearance of a transfer paper used in a thermal transfer printing device with a marking function according to an embodiment of the present invention;

FIG. 4 is a schematic side view illustrating a printing device with a marking function according to an embodiment of the present invention; and

FIG. 5 is a schematic side view illustrating the printing device of FIG. 4 and taken along another viewpoint.

FIGS. 6 is a schematic side view illustrating a making member of an identification module in accordance with one of preferred embodiments of the present invention;

FIG. 7 is another schematic side view illustrating the marking member of the identification module in accordance with another preferred embodiment of the present invention.

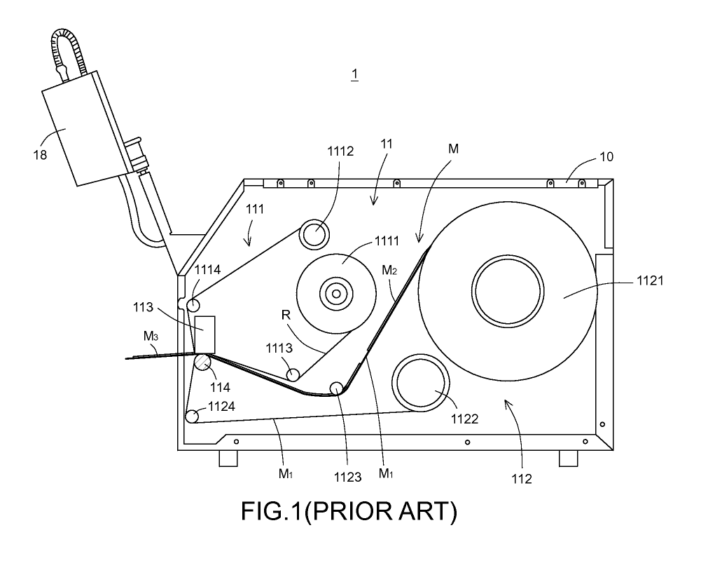

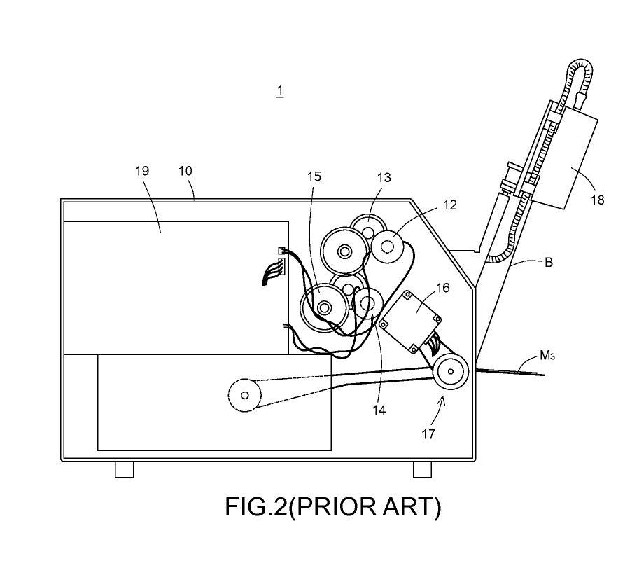

### DETAILED DESCRIPTION OF THE PREFERRED EMBODIMENT

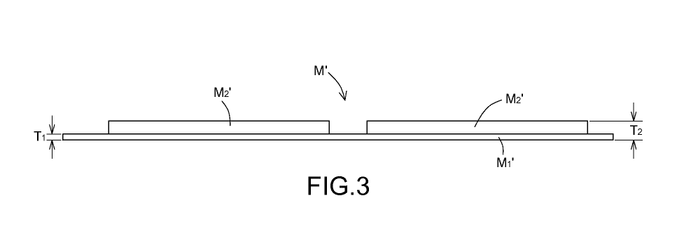

For obviating the drawbacks encountered from the prior art, the present invention provides a printing device with a marking function. FIG. 3 is a schematic side view illustrating the outward appearance of a transfer paper used in a thermal transfer printing device with a marking function according to an embodiment of the present invention. As shown in FIG. 3, the transfer paper M′ comprises a releasing paper part M1′ and a medium part M2′ disposed on the releasing paper part M1′. The top surface of the medium part M2′ is a blank surface. The bottom surface of the medium part M2′ is coated with an adhesive, so that the medium part M2′ may be adhered to the releasing paper part M1′. As shown in FIG. 3, the releasing paper part M1′ has a first thickness T1. In addition, the releasing paper part M1′ is stacked on the medium part M2′, and the overall thickness of the transfer paper M′ is equal to a second thickness T2.

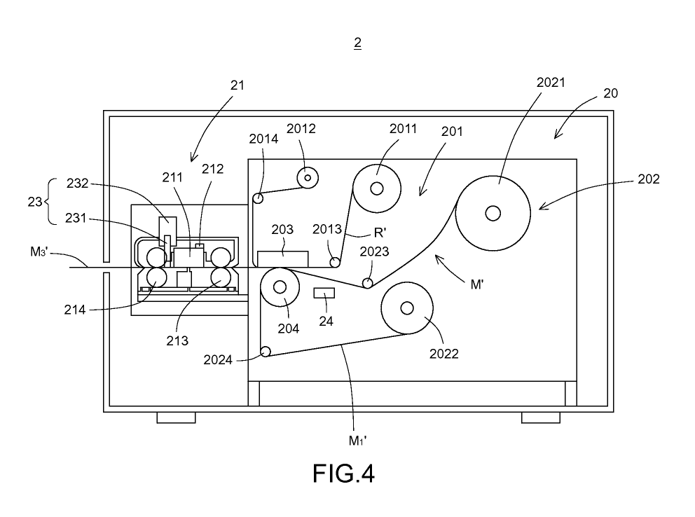

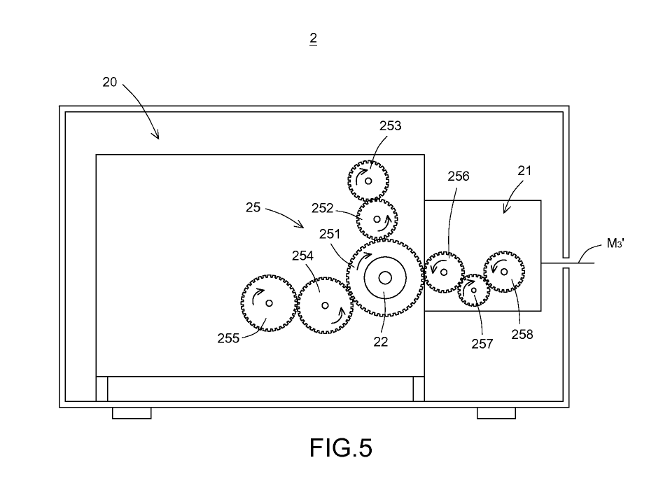

Hereinafter, the configurations of the printing device 2 with a marking function according to the present invention will be illustrated with reference to FIGS. 4 and 5. FIG. 4 is a schematic side view illustrating a printing device with a marking function according to an embodiment of the present invention. FIG. 5 is a schematic side view illustrating the printing device of FIG. 4 and taken along another viewpoint. The printing device 2 comprises a printing module 20, an identification module 21, a power-providing device 22, a marking member 23, a sensor 24 and a gear set 25. The printing module 20 is used for printing images on the blank medium part M2′ to produce a barcode paper M3′ (i.e. a printed medium part M2′), and transporting the barcode paper M3′. The identification module 21 is arranged beside the printing module 20. In addition, the identification module 21 has a preset standard of barcode. This preset barcode standard of the present invention is serial conditions that are pre-determined according to various barcode standard parameters such as, the linear barcode requirements or 2D matrix symbol requirements. The preset barcode conditions are also pre-measured up to the international and industry standards so that the barcode conditions and measurements (parameters) are adjustable in accordance with different barcode requirements and usages. Since measurements and parameters of the preset barcode standard are adjustable in accordance with different barcode standards, the identification module 21 is specifically designed to adopt for this purpose, such as the scanning element 211 and the controlling unit 212 of the identification module 21 are designed to adopt quickly any alternation in the preset barcode standard.

Once the barcode conditions and measurements are pre-set. The identification module 21 determines and analyzes each grade of the parameters of the barcode paper M3′ as well as its scan reflectance profile in accordance with the measurements already preset in the preset barcode standard. The optical characteristics and conditions of the barcode are also measured by the identification module 21 to determine whether this particular barcode paper M3′ is qualified or not. When the identification module 21 of the present invention inspects the conditions and standards of the barcode paper M3′ are measured up to the preset barcode standard or not. The qualified barcode paper M3′ would be sent out from the printing module 20. The power-providing device 22 is connected with the printing module 20 and the identification module 21 for providing motive power to the printing module 20 and the identification module 21. The marking member 23 is connected with the identification module 21. In a case that the identification module 21 judges that the barcode paper M3′ is different from the preset barcode standard, the marking member 23 produces a mark on the barcode paper M3′. The sensor 24 is connected with the printing module 20 and arranged in the vicinity of the printing module 20 for detecting the thickness of the transfer paper M′. The gear set 25 is connected with the power-providing device 22, the printing module 20 and the identification module 21 for receiving the motive power from the power-providing device 22, and transmitting the motive power to the printing module 20 and the identification module 21. Whenever there is a barcode paper M3′ not qualified and being marked by the marking member 23, a signal is sent to the controlling unit 212 and the printing module 20 to print an extra barcode paper M3′ to make up the loss of the rejected barcode paper M3′. Once the disqualified barcode paper M3′ is identified and marked, it is sent out directly from the printing module 20 without rolling back to the printing module 20.

The detailed structures of the components of the printing device 2 will be illustrated as follows. As shown in FIG. 4, the printing module 20 comprises a ribbon transport module 201, a transfer paper transport module 202, a thermal print head 203 and a print roller 204. By the ribbon transport module 201, a ribbon R′ is transmitted from a ribbon supplying terminal 2011 to a ribbon recovering terminal 2012. By the transfer paper transport module 202, the transfer paper M′ is transmitted from a transfer paper supplying terminal 2021 to a transfer paper recovering terminal 2022. The thermal print head 203 is arranged between the ribbon transport module 201 and the transfer paper transport module 202 for printing images on the medium part M2′ of the transfer paper M′ through the ribbon R′. In such way, a thermal transfer printing operation is performed to print the medium part M2′ as the barcode paper M3′. The print roller 204 is arranged beside the thermal print head 203 for transporting the transfer paper M′, so that the barcode paper M3′ of the transfer paper M′ is transmitted to the identification module 21 and the releasing paper part M1′ of the transfer paper M′ is transmitted to the transfer paper recovering terminal 2022.

Please refer to FIG. 4 again. In addition to the ribbon supplying terminal 2011 and the ribbon recovering terminal 2012, the ribbon transport module 201 further comprises a first tension shaft 2013 and a second tension shaft 2014. The first tension shaft 2013 is arranged between the ribbon supplying terminal 2011 and the thermal print head 203 for applying a first tension force to the ribbon R′. The second tension shaft 2014 is arranged between the thermal print head 203 and the ribbon recovering terminal 2012 for applying the first tension force to the ribbon R′. In addition to the transfer paper supplying terminal 2021 and the transfer paper recovering terminal 2022, the transfer paper transport module 202 further comprises a third tension shaft 2023 and a fourth tension shaft 2024. The third tension shaft 2023 is arranged between the transfer paper supplying terminal 2021 and the thermal print head 203 for applying a second tension force to the transfer paper M′. The fourth tension shaft 2024 is arranged between the thermal print head 203 and the transfer paper recovering terminal 2022 for applying the second tension force to the transfer paper M′.

Refer to FIGS. 4 and 6-7, the identification module 21 comprises a scanning member 211, a controlling unit 212, a first transport roller assembly 213 and a second transport roller assembly 214. The scanning element 211 is used for scanning the barcode paper M3′, thereby acquiring a scanned barcode image. The controlling unit 212 is connected with the scanning element 211. The preset barcode standard is stored in the controlling unit 212. By comparing the scanned barcode image with the preset barcode standard, the controlling unit 212 may judge whether the scanned barcode image is identical to the preset barcode standard. In a preferred embodiment, the scanning element 211 utilizes a contact image sensor (CIS) to scan and inspect the barcode paper M3′, wherein the controlling unit 212 is a microprocessor. The first transport roller assembly 213 is arranged at a first side of the scanning element 211 for transporting the barcode paper M3′ through the scanning element 211. The second transport roller assembly 214 is arranged at a second side of the scanning element 211 for transporting the barcode paper M3′ to be departed from the scanning element 211. The identification module 21 utilizes the CIS to scan the barcode images on the barcode paper M3′ without moving its scanning element 211. Unlike those conventional barcode printers, the scanning element 211 does not need to move its head along the barcode paper in order to read barcode.

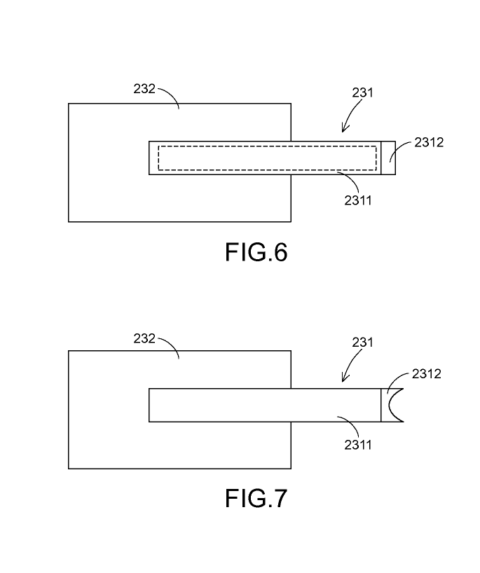

Refer to FIGS. 6 and 7, the marking member 23 comprises a marking head 231 and a solenoid valve 232. In accordance with one of the preferred embodiments of the present invention, the marking head 231 is used for producing a mark on the barcode paper M3′. In FIG. 7, the solenoid valve 232 is coupled with the marking head 231, which further comprises a shaft 2311 and a marking pad 2312 with a sharp edge. The solenoid valve 232 guides the marking head 231 to move in a motion with respect to the barcode paper M3′, away or toward the barcode paper M3′. The shaft 2311 and the marking pad 2312 are for example made of metal with a punching head, a pad with sharp edge(s), a trimming knife or any other marking tool for making a mark or an opening on the disqualified barcode paper M3′. Corresponding to the marking pad 2312 of the marking head 231, the mark is an unqualified symbol, an opening or a notch. In this embodiment according to FIG. 7, the marking head 231 is a punching head, and the mark is an opening. The mark or opening can be made at the central portion of the barcode paper M3′without any limitation to various paper sizes to identify the disqualified barcode paper M3′.

FIG. 6 demonstrates another preferred embodiment of the present invention, the marking member 23 comprises a marking head 231 connected to a solenoid valve 232. The marking head 231 further comprising a shaft 2311 and a marking pad 2312, wherein the shaft 2311 contains ink. The shaft 2311 of the marking head 231 is acted like an ink cartridge, in which is functioned like a pen-ball cartridge. The ink in the shaft 2311 is injected out once the marking pad 2312 is pressured to create a marking effect on the disqualified barcode paper M3′. The shaft 2311 is made of metal or other materials that are capable of carrying ink. The marking pad 2312 is made of rubber, sponge or other materials that are capable of producing marks or stamp effect on the disqualified barcode paper M3′.

It is noted that the marking pad 2312 and the shaft 2311 are designed to provide punch, stamp or any other ways of marking effect to identify the disqualified barcode paper M3′. Therefore, the marking pad 2312 and the shaft 2311 of present invention are not restricted or limited to the disclosed embodiments shown in FIGS. 6-7, other marking methods or designs of identifying the disqualified barcode paper M3′ can be made or utilized in the marking member 23 of the present invention. The marking pad 2312 and the shaft 2311 are replaceable and refillable for ink. According to another preferred embodiment of the present invention, the two different types of marking head 231, such as stamping and punching, can be installed in the marking member 23 for different purposes. The controlling unit 212 of the identify module 21 can determine when to use the stamp marking pad 2312 (Fig.6) or the punching marking pad 2312 (Fig.7) to identify the quality of the barcode paper M3′ in accordance with the preset barcode standard.

Please refer to FIG. 5. The gear set 25 comprises a driving gear 251, a first adjusting gear 252, a ribbon driving gear 253, a second adjusting gear 254, a transfer paper driving gear 255, a first transmission gear 256, a third adjusting gear 257 and a second transmission gear 258. The power-providing device 22 is connected with the driving gear 251 to rotate the driving gear 251 in the clockwise direction (in the viewpoint of FIG. 5). In this embodiment, the power-providing device 22 is a motor.

The mechanism of receiving the motive power by the printing module 20 will be illustrated as follows. Since the first adjusting gear 252 is engaged with the driving gear 251, the first adjusting gear 252 is synchronously rotated with the driving gear 251. In addition, since the first adjusting gear 252 is engaged with the ribbon driving gear 253, the ribbon driving gear 253 is rotated with the first adjusting gear 252. In this embodiment, the first adjusting gear 252 is rotated in the anti-clockwise direction, and the ribbon driving gear 253 is rotated in the clockwise direction. Since the ribbon driving gear 253 is connected with the ribbon recovering terminal 2012, the ribbon R is transported to the ribbon recovering terminal 2012 upon rotation of the ribbon recovering terminal 2012. Similarly, since the second adjusting gear 254 is engaged with the driving gear 251, the second adjusting gear 254 is synchronously rotated with the driving gear 251. In addition, since the second adjusting gear 254 is engaged with the transfer paper driving gear 255, the transfer paper driving gear 255 is rotated with the second adjusting gear 254. In this embodiment, the second adjusting gear 254 is rotated in the anti-clockwise direction, and the transfer paper driving gear 255 is rotated in the clockwise direction. Since the transfer paper driving gear 255 is connected with the transfer paper recovering terminal 2022, the releasing paper part M1′ of the transfer paper M′ is transported to the transfer paper recovering terminal 2022 upon rotation of the transfer paper recovering terminal 2022.

The mechanism of receiving the motive power by the identification module 21 will be illustrated as follows. The first transmission gear 256 is connected with the first transport roller assembly 213, and the second transmission gear 258 is connected with the second transport roller assembly 214. Since the first transmission gear 256 is engaged with the driving gear 251, the first transmission gear 256 is synchronously rotated with the driving gear 251. In addition, since the third adjusting gear 257 is engaged with the second transmission gear 258, the second transmission gear 258 is rotated with the third adjusting gear 257. In this embodiment, the third adjusting gear 257 is rotated in the clockwise direction, and the first transmission gear 256 and the second transmission gear 258 are rotated in the anti-clockwise direction. Consequently, as the first transmission gear 256 and the second transmission gear 258, the barcode paper M3′ will be transported. From FIG. 5, it is noted that the power-providing device 22 is connected with the printing module 20 and the identification module 21 through the gear set 25 for providing the motive power to the printing module 20 and the identification module 21.

Hereinafter, the operations of the printing device 2 with the marking function will be illustrated with reference to FIGS. 4 and 5. During the operation of the printing device 2, the printing module 20 and the identification module 21 are enabled, so that the transfer paper M′ and the ribbon R′ are transported through the region between the thermal print head 203 and the print roller 204. If the passage of the transfer paper M′ and the first thickness T1 of the transfer paper M′ are detected by the sensor 24, it means that only the releasing paper part M1′ of the transfer paper M′ (excluding the medium part M2′) passes through the sensor 24. Whereas, if the second thickness T2 of the transfer paper M′ is detected by the sensor 24, it means that the combination of the releasing paper part M1′ and the medium part M2′ passes through the sensor 24. In this situation, the sensor 24 issues a driving signal to the printing module 20. At the moment when the printing module 20 is enabled, the controlling unit 212 starts to count time. After the controlling unit 212 has counted time for a predetermined time period, the scanning element 211 is enabled by the controlling unit 212 to perform a scanning operation.

After the printing module 20 is enabled, the thermal print head 203 will heat the ribbon R′ to allow the coating of the ribbon R′ to be adsorbed on the medium part M2′ of the transfer paper M′. In such way, a thermal transfer printing operation is performed to print the medium part M2′ as a barcode paper M3′. In addition, the print roller 204 may facilitate the thermal print head 203 to perform the thermal transfer printing operation and transport the transfer paper M′. Consequently, the releasing paper part M1′ is transmitted to the transfer paper recovering terminal 2022, and the barcode paper M3′ is transmitted to the identification module 21. After the barcode paper M3′ is transmitted to the identification module 21 for the predetermined time period, the scanning element 211 is enabled to perform the scanning operation. Next, the barcode paper M3′ is transported through the scanning element 211 by the first transport roller assembly 213, so that the barcode paper M3′ is scanned by the scanning element 211 to acquire the scanned barcode image. Then, the scanned barcode image is compared with the preset barcode standard. If the controlling unit 212 judges that the scanned barcode image from the barcode paper M3′ is identical to the preset barcode standard, the marking element 23 is disabled and the barcode paper M3′ is continuously transported by the second transport roller assembly 214 to be departed from the printing module 20. Whereas, if the scanned barcode image is different from the preset barcode standard, the solenoid valve 232 of the marking member 23 is enabled. Then, the marking head 231 connected with the solenoid valve 232 is moved downwardly to contact with the barcode paper M3′ and punch an opening in the centre of the barcode paper M3′ with respect to the size and dimensions of the barcode paper M3′, and the barcode paper M3′ is transported by the second transport roller assembly 214 to be departed from the printing module 20 directly without reversing the unqualified barcode paper back to the thermal print head 203 and the print roller 204. In other words, once the disqualified barcode paper M3′ is identified and marked, it is sent out directly. Therefore, the barcode paper M3′ is proceeded from the printing module 20, the identification module 21 to the marking member 23, and out of the printing device 2 without returning back to the thermal print head 203 and the print roller 204 of the printing module 20 disregard whether the barcode paper M3 is qualified or rejected, In such way, the user determines whether the barcode paper M3′ is qualified or not by inspecting whether there is an opening in the barcode paper M3′. The unqualified barcode paper M3′ is punched with the opening in the centre of the paper in accordance with the dimensions of the barcode paper M3′ thus, various sizes of barcode papers are allowed to be used in the printing device 2.

From the above description, the printing device 2 of the present invention has a marking function as well as a punching function. Since the identification module 21 and the marking member 23 are arranged at a downstream side of the printing module 20, and CIS method is utilized to inspect and identify the unqualified barcodes. The barcode paper is successively transported through the printing module 20, the identification module 21 and the marking member 23. In this situation, if the barcode paper is deemed to be unqualified, the barcode paper dose not need to be returned back to the thermal print head 203 and the print roller 204. The barcode paper is continuously moved forwardly and then the marking member produces the mark on the unqualified barcode paper. The controlling unit 212 of the identification module 21 will send a signal to the printing module 20 and transport module 202 to print an additional barcode paper M3′ to make up the loss of the rejected (unqualified) barcode paper M3′. In other words, the printing device 2 of the present invention does not need complex control and precise computation to process the unqualified barcode paper M3′. Consequently, the printing device 2 of the present invention does not use three power-providing devices to respectively drive the ribbon transport module, the transfer paper transport module and the print roller. Since a single power-providing device is used to simultaneously drive the ribbon transport module, the transfer paper transport module and the print roller, the printing device 2 of the present invention is more cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing device with a marking function, the printing device comprising:
a printing module for performing a printing operation to produce a barcode paper, and transporting the barcode paper;
an identification module disposed beside the printing module, and having a preset barcode standard, wherein the identification module determines whether the barcode paper is consistent with the preset barcode standard;
a power-providing device connected with the printing module and the identification module for providing power to the printing module and the identification module; and
a marking member connected with the identification module, wherein the marking member further comprises a marking head coupling to a solenoid valve for moving the marking head with respect to the barcode paper, when the barcode paper is inconsistent with the preset barcode standard, the marking head of the marking member produces a mark on the barcode paper,
wherein the barcode paper is successively transported through the printing module, the identification module and the marking member.

2. The printing device with a marking function according to claim 1 wherein the printing module comprises:
a ribbon transport module for transmitting a ribbon from a ribbon supplying terminal to a ribbon recovering terminal;
a transfer paper transport module for transmitting a transfer paper from a transfer paper supplying terminal to a transfer paper recovering terminal, wherein the transfer paper comprises a releasing paper part and a medium part disposed on the releasing paper part;
a thermal print head arranged between the ribbon transport module and the transfer paper transport module for performing the printing operation on the medium part of the transfer paper through the ribbon, thereby printing the medium part as the barcode paper; and
a print roller arranged beside the thermal print head for transporting the transfer paper, so that the transfer paper is transmitted to the identification module.

3. The printing device with a marking function according to claim 2 wherein the ribbon transport module comprises:
a first tension shaft arranged between the ribbon supplying terminal and the thermal print head for applying a first tension force to the ribbon; and
a second tension shaft arranged between the thermal print head and the ribbon recovering terminal for applying the first tension force to the ribbon.

4. The printing device with a marking function according to claim 2 wherein the transfer paper transport module comprises:
a third tension shaft arranged between the transfer paper supplying terminal and the thermal print head for applying a second tension force to the transfer paper; and
a fourth tension shaft arranged between the thermal print head and the transfer paper recovering terminal for applying the second tension force to the transfer paper.

5. The printing device with a marking function according to claim 2, wherein the printing device further comprises a sensor, which is connected with the printing module for detecting a thickness of the transfer paper, wherein when the thickness of the transfer paper detected by the sensor is changed from a first thickness to a second thickness greater than the first thickness, the sensor issues a driving signal to the printing module to enable the printing module, wherein the first thickness is equal to a thickness of the releasing paper part, and the second thickness is equal to an overall thickness of the medium part and the releasing paper part.

6. The printing device with a marking function according to claim 1 wherein the identification module comprises:
a scanning element for scanning the barcode paper, thereby acquiring a scanned barcode image;
a controlling unit connected with the scanning element, and storing the preset barcode standard, wherein by comparing the scanned barcode image with the preset barcode standard, the controlling unit judges whether the scanned barcode image is identical to the preset barcode standard;
a first transport roller assembly arranged at a first side of the scanning element for transporting the barcode paper through the scanning element; and
a second transport roller assembly arranged at a second side of the scanning element for transporting the barcode paper to be departed from the scanning element.

7. The printing device with a marking function according to claim 6 wherein the scanning element is a contact image sensor (CIS).

8. The printing device with a marking function according to claim 1, wherein the marking head is a seal, a punching head or a trimming knife, and the mark is an unqualified symbol, an opening or a notch.

9. The printing device with a marking function according to claim 1 wherein the printing device further comprises a gear set, wherein the gear set is connected with the power-providing device, the printing module and the identification module for receiving the motive power from the power-providing device, and transmitting the motive power to the printing module and the identification module.
